(19) United States
(12) Patent Application Publication
(10) Pub. No.: US 2013/0233791 A1
(43) Pub. Date: Sep. 12, 2013

(54) SEPARATION MEMBRANE FOR WATER TREATMENT AND MANUFACTURING METHOD THEREOF

(71) Applicant: KOREA INSTITUTE OF SCIENCE AND TECHNOL, Seoul (KR)

(72) Inventors: Chong Min KOO, Gyeonggi-do (KR); Kyung Youl BAEK, Seoul (KR); Seung Sang HWANG, Seoul (KR); Soon Man HONG, Seoul (KR); Ho Bum PARK, Seoul (KR); Ji Young JUNG, Daejeon (KR); Jang Woo LEE, Gyeonggi-do (KR); Young Hoon CHO, Seoul (KR); Seung Gun YU, Seoul (KR); Sang Hee PARK, Seoul (KR)

(73) Assignee: KOREA INSTITUTE OF SCIENCE AND TECHNOLOGY, Seoul (KR)

(21) Appl. No.: 13/647,465

(22) Filed: Oct. 9, 2012

(30) Foreign Application Priority Data
Mar. 8, 2012 (KR) 10-2012-0024055

(51) Int. Cl. B01D 71/68; B01D 71/06; B01D 71/36; B01D 71/38; B29C 35/00; B01D 71/56; B01D 71/40; B01D 71/28; B01D 71/42; B01D 71/34; B01D 63/00; B01D 71/64

(52) U.S. Cl. 210/500.34; 210/500.21; 210/500.27; 210/500.37; 210/500.33; 210/500.28; 210/500.38; 210/500.41; 210/500.35; 210/500.43; 210/500.42; 264/413

(57) ABSTRACT

The present invention relates to a separation membrane for water treatment having high water flux and membrane contamination preventing characteristics, and a manufacturing method thereof. The separation membrane for water treatment according to the present invention includes a nanofiber wherein the separation membrane has a surface electric charge. According to the present invention, a separation membrane for water treatment having high water flux and membrane contamination preventing characteristics, and a manufacturing method thereof may be implemented.

### CROSS-REFERENCE TO RELATED APPLICATION

This application claims priority to and the benefit of Korean Patent Application No. 2012-0024055, filed on Mar. 8, 2012, the disclosure of which is incorporated herein by reference in its entirety.

### BACKGROUND

1. Field of the Invention

The present invention relates to a separation membrane for water treatment and a manufacturing method thereof, and more particularly, to a separation membrane for water treatment having the characteristics of high water flux and preventing a membrane contamination and a manufacturing method thereof.

2. Discussion of Related Art

Recently, there has been an increasing interest in separation membranes due to their many advantages such as stability of water quality, compact site requirements, automation and the like, in the water purification treatment process.

Most separation membranes used in water purification treatment require strong durability, long life span and the like, and membrane-contaminating resistance is greatly required for this purpose. Thus, there has been an increasing need for a separation membrane having excellent mechanical strength, high permeate flow rate and high membrane-contaminating resistance.

A phenomenon that contaminant particles in the membrane separation process are adsorbed on the membrane surface while being filtered on the membrane surface to block the pores of the membrane, thereby significantly reducing the operating pressure of the membrane, and the throughput of raw water refers to fouling, and may serve as an element to significantly shorten the lifespan of the membrane.

A serious fouling problem may be caused in the separation of a contaminant material, and as a method for reducing the fouling problem, various methods, such as pretreatment of raw water in the water treatment process, modification of the surface of a separation membrane, periodic cleaning and the like, have been used.

As a representative of the investigations to prevent fouling, there is a method, including; manufacturing a membrane which is electrically charged to prevent the membrane from being contaminated by electrical repulsion with the contaminant material, but in this case, effects of preventing the membrane from being contaminated are excellent, but the high porous nanofiber membrane with strong durability and long lifespan may be difficult to form due to either poor durability of the ionic polymers to the water or poor nanofiber electrospinnability of the ionic polymers with aggregates of ionic groups.

In the present invention, the reduction of efficiency of the membrane is prevented by manufacturing a porous nanofiber membrane in order to solve the problems.

### SUMMARY OF THE INVENTION

The present invention is directed to a separation membrane for water treatment having high water flux and membrane contamination prevention characteristics and a manufacturing method thereof.

According to an aspect of the present invention, there is provided a separation membrane for water treatment, including: a nanofiber, wherein the separation membrane has a surface electric charge.

The nanofiber may form a network shape.

The nanofiber may have an average diameter between 10 nm and 1,000 nm.

The nanofiber may include an ionic polymer and a nonionic polymer.

The ionic polymer may include an ionic functional group.

The ionic functional group may include one or more selected from the group consisting of sulfonate, carboxylate, phosphate, amine and ammonium.

The ionic polymer having the one or more functional groups selected from the group consisting of sulfonate, carboxylate and phosphate may include one or more selected from the group consisting of nation, sulfonated polyether ether ketone and carboxylated polyether ether ketone.

The ionic polymer having the one or more functional groups selected from the group consisting of amine and ammonium may include one or more selected from the group consisting of polydiallyldimethylammonium chloride, cationic polyacrylamide and aminated polyethersulfone.

The nonionic polymer may have no ionic functional group.

The nonionic polymer may include one or more selected from the group consisting of polymethyl methacrylate (PMMA), polystyrene (PS), polycaprolactone (PEI), polyacrylonitrile (PAN), polyvinylidene fluoride (PVDF), polyvinylpyrrolidone (PVP) and polyvinyl alcohol (PVA).

The content of the ionic polymer may be 1% by weight to 90% by weight based on the content of the nonionic polymer.

The surface electric charge may have a zeta potential value of −70 mV to −10 mV at pH 10.

The surface electric charge may have a zeta potential value of 10 mV to 70 mV at pH 2.

Porosity may be 60% to 90%.

According to another aspect of the present invention, there is provided a method for manufacturing a separation membrane for water treatment, including: mixing an ionic polymer with a nonionic polymer to prepare a mixed solution; using an electrospinning method to manufacture a separation membrane including nanofibers from the mixed solution; and subjecting the separation membrane to heat treatment.

The ionic polymer may include an ionic functional group.

The ionic functional group may include one or more selected from the group consisting of sulfonate, carboxylate, phosphate, amine and ammonium.

The ionic polymer having the one or more functional groups selected from the group consisting of sulfonate, carboxylate and phosphate may include one or more selected from the group consisting of nafion, sulfonated polyether ether ketone and carboxylated polyether ether ketone.

The ionic polymer having the one or more functional groups selected from the group consisting of amine and ammonium may include one or more selected from the group consisting of polydiallyldimethylammonium chloride, cationic polyacrylamide and aminated polyethersulfone.

The nonionic polymer may include a polymer having no ionic functional group.

The nonionic polymer may include one or more selected from the group consisting of polymethyl methacrylate (PMMA), polystyrene (PS), polycaprolactone (PCL), polyacrylonitrile (PAN), polyvinylidene fluoride (PVDF), polyvinylpyrrolidone (PVP) and polyvinyl alcohol (PVA).

The ionic polymer may be added in the amount of 1% by weight to 90% by weight based on the content of the nonionic polymer.

The nanofiber may have an average diameter between 10 nm and 1,000 nm.

The heat-treated separation membrane may have a porosity of 60% to 90%.

According to the present invention, a separation membrane for water treatment having high water flux and membrane contamination preventing characteristics, and a manufacturing method thereof may be implemented. Further, operation costs may be reduced and the lifespan of the separation membrane may be maintained for a long time.

That is, a separation membrane for water treatment having an electric, charge, which includes a nanofiber web prepared by electrospinning, and has a porous structure, and thus the operation energy may be reduced because the separation membrane has high water flux and the throughput of raw water is increased. In addition, the lifespan of the membrane may be maintained for a long time by preventing a contaminant material having an electric charge from being adsorbed on the surface of the membrane by electrostatic repulsion.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating the internal structure of a separation membrane for water treatment according to an embodiment of the present invention; and

FIG. 2 is a scanning electron microscope photo of a separation membrane for water treatment according to an embodiment of the present invention.

### DETAILED DESCRIPTION OF EXEMPLARY EMBODIMENTS

Exemplary embodiments of the present invention will be described in detail below with reference to the accompanying drawings.

Embodiments of the present invention may be modified in various forms, and the scope of the present invention is not limited to the embodiments which will be described below.

Further, embodiments of the present invention are provided in order to more completely explain the present invention to those skilled in the art. Therefore, the shape and size of elements in the drawings may be exaggerated for clarity, and elements designated by the same reference numeral in the drawing are the same elements.

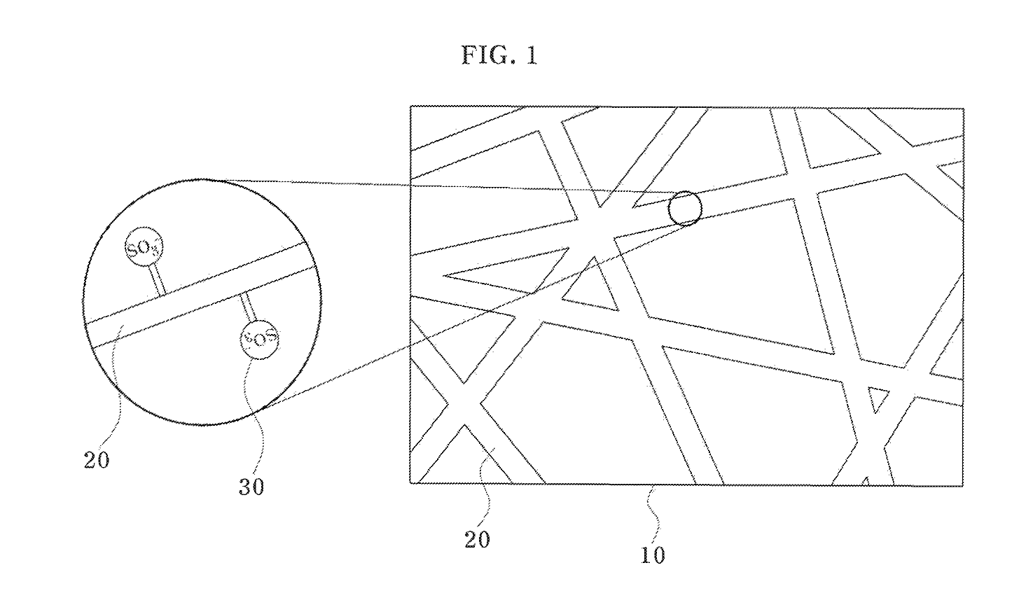

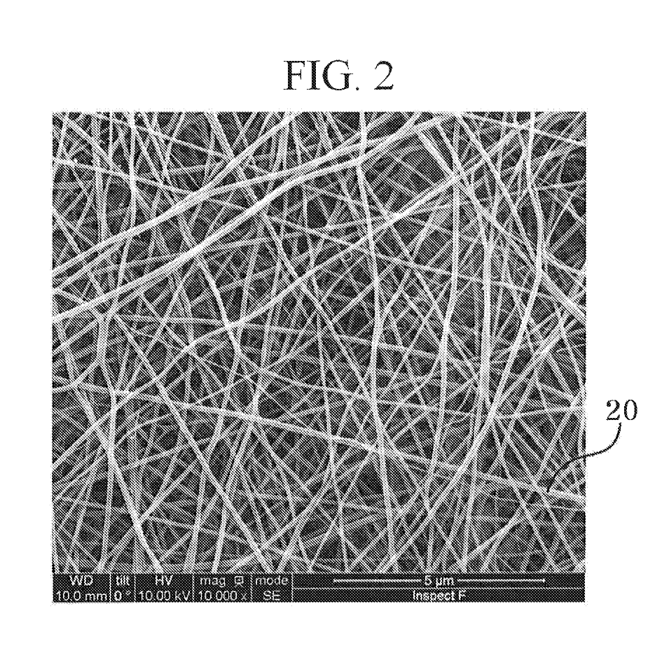

FIG. 1 is a schematic view illustrating the internal structure of a separation membrane for water treatment according to an embodiment of the present invention. FIG. 2 is a scanning electron microscope photo illustrating the internal structure of a separation membrane for water treatment according to an embodiment of the present invention.

Referring to FIGS. 1 and 2, a separation membrane for water treatment 10 which is an embodiment of the present invention may include a nanofiber 30 and have a surface electric charge 20.

The separation membrane for water treatment may have a structure in which nanofibers are entangled with each other, that is, a network structure. Water may permeate through pores present in the network structure, and contaminant materials may be filtered during the process.

During the process, contaminant materials may be adsorbed on the separation membrane to rather contaminate the separation membrane, and in this case, the function of the separation membrane may deteriorate, such as an increase in pressure and the like.

The nanofiber may include an ionic polymer and a nonionic polymer.

The nanofiber may mean a fiber having an average diameter in the nanometer level. The nanofiber may be manufactured by an electrospinning method, and the electrospinning method will be described afterwards.

The ionic polymer means a polymer including ions, and may be electrically charged by ions. It may not be easy to form a nanofiber by using only the ionic polymer. The strong interaction between ionic groups of ionic polymer form aggregates and this characteristic may disturb the chain entanglement of polymer main chains. The present embodiment is to solve the problem by using a blend in which an ionic polymer and a nonionic polymer are mixed.

The ionic polymer may include an ionic functional group, and the ionic functional group may include one or more selected from the group consisting of sulfonate, carboxylate, phosphate, amine and ammonium.

The polymer having sulfonate, carboxylate and phosphate functional groups is not limited thereto, but may include nation (a trade name of Du Pont Corp., a polymer in which a sulfonic acid group is introduced into the backbone of polytetrafluoroethylene, and hereinafter, referred to as “nafion”), and sulfonated or carboxylated polyetherether ether ketone.

In addition, the polymer having amine and ammonium functional groups is not limited thereto, but may include polydiallyldimethylammonium chloride, cationic polyacrylamide, aminated polyethersulfone and the like.

The nonionic polymer means a polymer having no ionic functional group, and may not be electrically charged.

The nonionic polymer may include one or more selected from the group consisting of polymethyl methacrylate (PMMA), polystyrene (PS), polycaprolactone (PCL), polyacrylonitrile (PAN), polyvinylidene fluoride (PVDF), polyvinylpyrrolidone (PVP) and polyvinyl alcohol (PVA). However, the kind thereof is not particularly limited.

The content of the ionic polymer may be 1% by weight to 90% by weight based on the content of the nonionic polymer.

When the content of the ionic polymer is less than 1% by weight, the surface electric charge value is small, and thus the function of preventing contamination may deteriorate When the content of the ionic polymer is more than 99% by weight, the content of the ionic polymer is large, and thus the chain entanglement of polymer main chains may be disturbed by the characteristic of the ionic polymer having a strong interaction between ionic groups, thereby making it difficult to form a nanofiber.

In the present embodiment, the nanofiber may have an average diameter between 10 nm and 1,000 nm.

When the average diameter of the nanofiber is less than 10 nm, it may be difficult to manufacture the nanofiber due to limitations on the manufacturing process. When the average diameter of the nanofiber is more than 1,000 nm, the surface area of the separation membrane for water treatment may be reduced, and thus the contact area of water and the separation membrane is reduced and the function of preventing contamination may deteriorate.

In the present embodiment, the surface electric charge characteristic of a separation membrane for water treatment may have a Zeta potential value of −70 mV to −10 mV at pH 10, or a Zeta potential value of 10 mV to 70 mV at pH 2.

When the Zeta potential value is a negative value, the separation membrane is negatively electrically charged, and the Zeta potential value may show the lowest value (the absolute value is a maximum value). When the Zeta potential value is a positive value, the separation membrane is positively electrically charged, and the Zeta potential value may show the maximum value at pH 2 or less.

When the absolute value of the Zeta potential is less than 10 mV, the surface electric charge characteristic of the separation membrane for water treatment is small and thus the function of preventing the separation membrane for water treatment from being contaminated may deteriorate. The upper limit of the absolute value of the Zeta potential is 70 mV, which is an attempt to show the lowest value that the Zeta potential value may have, and in conclusion, this means that the function of preventing the separation membrane for water treatment may be properly performed if the absolute value of the Zeta potential is 10 mV or higher.

In the present embodiment, the separation membrane for water treatment may have a porosity of 60% to 90%.

When the porosity of the separation membrane for water treatment is less than 60%, the performance of the separation membrane for water treatment may deteriorate, and when the porosity of the separation membrane for water treatment is more than 90%, it may be difficult to manufacture the separation membrane for water treatment.

The method for manufacturing a separation membrane for water treatment, which is another embodiment of the present invention, may include: mixing an ionic polymer with a nonionic polymer to prepare a mixed solution; using an electrospinning method to manufacture a separation membrane including nanofibers from the mixed solution; and subjecting the separation membrane to heat treatment.

First, the ionic polymer and the nonionic polymer may be mixed to prepare a mixed solution.

A solvent having excellent solubility of the ionic polymer and the nonionic polymer may be used to prepare a mixed solution of the ionic polymer and the nonionic polymer. For example, when a mixed solution of nafion and polyvinylidene fluoride is prepared, dimethylformamide may be used as the solvent.

Next, the electrospinning method may be used to manufacture a separation membrane including nanofibers from the mixed solution.

The nanofiber may be manufactured by the electrospinning method, and the electrospinning method is a technology to impart an electrostatic force to a polymer solution or a molten body to form a fiber in a range of several nm to several μm.

If a sufficiently large voltage is applied to a solution drop which forms a semi-spherical form at the tip of a capillary tube due to the surface tension thereof, the solution drop may be elongated in the form of a cone known as the Taylor cone by an electric field applied in a direction opposite to the surface tension.

If a voltage equal to or more than the critical electric field is applied, the surface tension of the solution drop is overcome and then a Jet is emitted from the Taylor cone. The solvent is evaporated while the emitted Jet is flying toward a current collector, and an electrically charged polymer nanofiber membrane may be obtained in the current collector.

The nanofiber membrane thus obtained has a very high porosity per unit volume and a high specific surface area, and the size of pores may be readily controlled by changing the diameter of the fiber.

Next, the separation membrane may be subjected to heat treatment.

This refers to an annealing step, and the separation membrane may be subjected to the annealing step to relieve stress and the like, which are present in the separation membrane in the manufacturing process and as a result, the separation membrane may be allowed to be put in a more stable state and the mechanical strength of the membrane may be increased through mergence of fibers. Further, the remaining solvent during the heat treatment process may be completely volatilized.

The ionic polymer may include an ionic functional group, and the ionic functional group may include one or more selected from the group consisting of sulfonate, carboxylate, phosphate, amine and ammonium.

A polymer having one or more functional groups selected from the group consisting of sulfonate, carboxylate and phosphate may include one or more selected from the group consisting of nation, sulfonated poly-ether ether ketone and carboxylated polyether ether ketone.

The polymer having one or more functional groups selected from the group consisting of amine and ammonium may include one or more selected from the group consisting of polydiallyldimethylammonium chloride, cationic polyacrylamide and aminated polyethersulfone.

The nonionic polymer may include a polymer having no ionic functional group, and specifically, may include one or more selected from the group consisting of polymethyl methacrylate (PMMA), polystyrene (PS), polycaprolactone (PCL), polyacrylonitrile (PAN), polyvinylidene fluoride (PVDF), polyvinylpyrrolidone (PVP) and polyvinyl alcohol (PVA).

The ionic polymer may be added in the amount of 1% by weight to 90% by weight based on the content of the nonionic polymer.

The nanofiber may have an average diameter between 10 nm and 1,000 nm.

The heat-treated separation membrane may have a porosity of 60% to 90%.

Details on other ionic polymers, nonionic polymers, nanofibers and the like are the same as what is described in the previous embodiment.

Hereinafter, the present invention will be described in detail with reference to Examples and Comparative Examples.

### Example 1

A nafion/polyvinylidene fluoride membrane was used in the separation membrane for water treatment according to Example 1, and the separation membrane was manufactured according to the following method.

A commercially available nafion solution with nation dissolved in the amount of 20% by weight and dimethylformamide (DMF) which has excellent solubility of nation and polyvinylidene fluoride, were prepared.

The solvent of the nation solution was evaporated and then a process of adding DMF thereto was repeated three times to substitute the solvent of the nation solution with DMF, thereby preparing a nation solution using DMF as a solvent.

Polyvinylidene fluoride in a weight equal to the weight of nafion was mixed to the nafion solution (ratio of the nafion weight to the polyvinylidene fluoride weight is 1:1), and the amount of the DMF solvent was controlled to allow the sum of the weights of nafion and the weight of polyvinylidene fluoride to be 30% based on the weight of the DMF solvent. The solution was stirred by a magnetic stirrer at 70° C. for approximately 5 hr to prepare a uniform solution.

The solution was put in a 10 ml syringe, a needle having an inner diameter of 21 G was inserted thereto, the assembly was mounted on an electrospinning apparatus, a voltage of 12 kV was applied between the needle tip and the collecting part, and the syringe was pushed at a discharge speed of 1.5 μm/min to obtain a nanofiber membrane. The distance between the needle tip and the collecting part was kept at 10 cm and the thickness of the nanofiber membrane was 30 μm.

The nanofiber membrane was subjected to heat treatment (annealing) in vacuum at 130° C. for 1 hr, and then subjected to heat treatment in air at 80° C. for 12 hrs to remove the remaining solvent.

### Example 2

A sulfonated polyether ether ketone/polyacrylonitrile membrane was used in the separation membrane for water treatment according to Example and the separation membrane was prepared according to the following method.

A separation membrane was manufactured in the same manner as in Example 1, except that the weight ratio of sulfonated polyether ether ketone to polyacrylonitrile was 70:30, and the sum of the weights of sulfonated polyether ether ketone and polyacrylonitrile was 20% based on the weight of the DMF solvent.

Conditions for forming the nanofiber membrane by electrospinning were the same as those in Example 1, but a voltage of 10 kV was applied while maintaining the discharge speed at 3 μm min.

### Example 3

An aminated polysulfone/polyvinylidene fluoride membrane was used in the separation membrane for water treatment, and the separation membrane was prepared by the following method:

A separation membrane was manufactured in the same manner as in Example 1, except that the weight ratio of aminated polysulfone to polyvinylidene fluoride was 40:60, and the sum of the weights of aminated polysulfone and polyvinylidene fluoride was 20% based on the weight of the toluene solvent.

Conditions for forming the nanofiber by using the electrospinning were the same as those in Example 1, but a voltage of 13 kV was applied while maintaining the discharge speed at 6 μm/min.

### Comparative Example 1

A polyvinylidene fluoride membrane manufactured by the electrospinning method was used in the separation membrane for water treatment according to the Comparative Example 1, and the separation membrane was prepared by the following method:

Acetone and dimethylacetamide (DMAc) were mixed in the same weight ratio to prepare a solvent, polyvinylidene fluoride was added thereto in the amount of 15% based on the weight of the solvent, and the resulting mixture was mixed while being stirred by a magnetic stirrer at 70 for 5 hrs to allow the mixture to be a transparent solution.

The electrospinning conditions were the same as those in Example 1, except that the external pressure, the discharge speed and the cylinder needle inner diameter were 8 kV, 30 μl/min, and 23 G, respectively, and the thickness of the manufactured nanofiber membrane was 30 μm.

### Comparative Example 2

A commercially available polytetrafluoroethylene (PTFE) membrane manufactured by a stretching method was used as the separation membrane for water treatment according to Comparative Example 2. The total thickness of the membrane was 30 μmand the average pore size was 0.45 μm.

Characteristics of the separation membrane for water treatment according to Examples 1 to 3 and Comparative Examples 1 and 2 are shown in Table 1.

The fiber diameter of the nanofiber was measured by using an UTHSCSA image tool from scanning electron microscope photos, and the average value thereof was obtained.

The porosity was calculated by the equation [(ρₐₚₚ−ρ_{bulk})/ρ_{bulk}]×100% (here, ρₐₚₚ is a density of the film with the same composition, and ρ_{bulk} is a density of the nanofiber).

The Zeta potential is a quantified value of the electric charge characteristic on the surface of the membrane by using the streaming potential (Anton Parr, Surpass), and was calculated in accordance with the equation ζ=(dU/dp)×(η/∈∈₀)k_{B} (here, p is pressure, U is the streaming potential, η is the viscosity of solution, E is the basic permittivity of an electrolyte, ∈₀ is a dielectric constant of an electrolyte, and k_{B}; is the electric conductivity of an electrolyte).

Water flux was evaluated by using a dead-end filtration cell (Amicon 8050, Millipore, USA; effective membrane area 13.4 cm²), and calculated in accordance with the equation J₀=V/(At) (here, V is the permeated volume, A is the size of the membrane, and t is time).

Water flux recovery (%) was calculated in accordance with the equation

Recovery=(Fₓ/F₀)×100(Fₓ is the water flux before the fouling, and F₀ is the water flux after the fouling).

Fouling was performed by allowing a solution to which protein was added to be permeated into the separation membrane. In the case of a negatively charged membrane as the protein, the bovine serum albumin (BSA) having a negative charge was used, and in the case of a positively charged membrane, the cytochrome C having a positive charge was used.

TABLE 1

| | Fiber | | | Water | Water |
|---|---|---|---|---|---|
| | di- | Poros- | Zeta | flux | flux |
| | ameter | ity | potential | (LMH/ | recovery |
| | (nm) | (%) | (mV) | bar) | (%) |
| Example 1 | 95 | 83 | −50 (pH 10) | 25,000 | 86 |
| Example 2 | 250 | 86 | −55 (pH 10) | 35,000 | 85 |
| Example 3 | 290 | 85 | 40 (pH 2) | 31,000 | 88 |
| Comparative | 150 | 83 | 1 (pH 2~10) | 30,000 | 66 |
| Example 1 | | | | | |
| Comparative | — | 57 | 2 (pH 2~10) | 17,000 | 68 |
| Example 2 | | | | | |

Referring to Table 1, the separation membranes for water treatment according to Examples 1 to 3 have a nanofiber diameter of 95 nm, 250 nm and 290 nm, a porosity of 83%, 86% and 85%, a Zeta potential of −50 mV, −55 mV and 40 mV, a water flux of 25,000 LMH/bar, 35,0000 LMH/bar and 31,000 LMH/bar, and a water flux recovery of 86%, 85% and 88%, respectively.

The separation membrane for water treatment according to Comparative Example 1 has a nanofiber diameter of 150 nm, a porosity of 83%, a Zeta potential of 1 mV, a water flux of 30,000 LMH/bar, and a water flux recovery of 66%.

The separation membrane for water treatment according to Comparative Example 1 has a value smaller than those in Examples 1 to 3, in water flux recovery. As can be known that the separation membranes for water treatment according to Comparative Examples had a Zeta potential close to 0 mV, it can be inferred that the water flux recovery is small because electrostatic repulsion between contaminant materials and the separation membrane is small.

The separation membrane for water treatment according to Comparative Example 2 has a porosity of 55%, a Zeta potential of 2 mV, a water flux of 17,000 LMH/bar, and a water flux recovery of 68%.

In the case of the separation membrane for water treatment according to Comparative Example 2, it can be confirmed that the water flux and the water flux recovery are significantly low compared to those in Examples 1 to 3. It can be inferred that the water flux is low because the porosity of the separation membrane is lower than 60%, and that the water flux recovery is low because the Zeta potential is close to 0 mV and as a result, electrostatic repulsion between the separation membrane and contaminant materials is small. The fact that the water reflux recovery is excellent means that the contamination preventing function of the separation membrane for water treatment is excellent.

In the case of Comparative Example 2, the porosity of the separation membrane is small because the separation membrane was manufactured not by the electrospinning method but by a stretching method.

In conclusion, according to Table 1, for the separation membrane composed of a nanofiber manufactured by the electrospinning method using a blend of the ionic polymer and the nonionic polymer, it can be confirmed that the water flux was high because the porosity was high, and that the water flux recovery, that is, the contamination preventing function was excellent because the separation membrane has a surface electric charge.

The terms used in the present invention are used only to describe specific embodiments, and are not limited to the present invention. A singular expression includes a plural meaning unless it is clearly mentioned in the context.

In the present application, it should be appreciated that the term “include (s)” or “have (has)” is intended to mean the existence of characteristics, numbers, steps, operations, elements, or combinations thereof described in the specification, but is not intended to exclude the possibility of existence or addition of one or more other characteristics or numbers, steps, operations, elements, or combinations thereof.

The present invention is not limited by the above-described embodiments and the accompanying, drawings, but by the accompanying claims.

Accordingly, those skilled in the art will appreciate that various substitutions, modifications and changes are possible, without departing from the technical spirit of the present invention as disclosed in the claims, and it is to be understood that such substitutions, modifications and changes are within the scope of the present invention.

1. A separation membrane for water treatment, comprising:
a nanofiber,
wherein the separation membrane has a surface electric charge.

2. The separation membrane for water treatment of claim 1, wherein the nanofiber forms a network shape.

3. The separation membrane for water treatment of claim 1, wherein the nanofiber has an average diameter between 10 nm and 1,000 nm.

4. The separation membrane for water treatment of claim 1, wherein the nanofiber comprises an ionic polymer and a nonionic polymer.

5. The separation membrane for water treatment of claim 4, wherein the ionic polymer comprises an ionic functional group.

6. The separation membrane for water treatment of claim 5, wherein the ionic functional group comprises one or more selected from the group consisting of sulfonate, carboxylate, phosphate, amine and ammonium.

7. The separation membrane for water treatment of claim 6, wherein the ionic polymer having the one or more functional groups selected from the group consisting of sulfonate, carboxylate and phosphate comprises one or more selected from the group consisting of nafion, sulfonated polyether ether ketone and carboxylated polyether ether ketone.

8. The separation membrane for water treatment of claim 6, wherein the ionic polymer having the one or more functional groups selected from the group consisting of amine and ammonium comprises one or more selected from the group consisting of polydiallyldimethylammonium chloride, cationic polyacrylamide and aminated polyethersulfone.

9. The separation membrane for water treatment of claim 3, wherein the nonionic polymer has no ionic functional group.

10. The separation membrane for water treatment of claim 9, wherein the nonionic polymer comprises one or more selected from the group consisting of polymethyl methacrylate (PMMA), polystyrene (PS), polycaprolactone (PCL), polyacrylonitrile (PAN), polyvinylidene fluoride (PVDF), polyvinylpyrrolidone (PVP) and polyvinyl alcohol (PVA).

11. The separation membrane for water treatment of claim 4, wherein the content of the ionic polymer is 1% by weight to 90% by weight based on the content of the nonionic polymer.

12. The separation membrane for water treatment of claim 1, wherein the surface electric charge has a zeta potential value of −70 mV to −10 mV at pH 10.

13. The separation membrane for water treatment of claim 1, wherein the surface electric charge has a zeta potential value of 10 mV to 70 mV at pH 2.

14. The separation membrane for water treatment of claim 1, wherein porosity is 60% to 90%.

15. A method for manufacturing a separation membrane for water treatment, comprising:
mixing an ionic polymer with a nonionic polymer to prepare a mixed solution;
using an electrospinning method to manufacture a separation membrane comprising nanofibers from the mixed solution; and
subjecting the separation membrane to heat treatment.

16. The method of claim 15, wherein the ionic polymer comprises an ionic functional group.

17. The method of claim 16, wherein the ionic functional group comprises one or more selected from the group consisting of sulfonate, carboxylate, phosphate, amine and ammonium.

18. The method of claim 17, wherein the ionic polymer having the one or more functional groups selected from the group consisting of sulfonate, carboxylate and phosphate comprises one or more selected from the group consisting of nation, sulfonated polyether ether ketone and carboxylated polyether ether ketone.

19. The method of claim 17, wherein the ionic polymer having the one or more functional groups selected from the group consisting of amine and ammonium comprises one or more selected from the group consisting of polydiallyldimethylammonium chloride, cationic polyacrylamide and aminated polyethersulfone.

20. The method of claim 15, wherein the nonionic polymer polymer having no ionic functional group.

21. The method of claim 15, wherein the nonionic polymer comprises one or more selected from the group consisting of polymethyl methacrylate (PMMA), polystyrene (PS), polycaprolactone (PCL), polyacrylonitrile (PAN), polyvinylidene fluoride (PVDF), polyvinylpyrrolidone (PVP) and polyvinyl alcohol (PVA).

22. The method of claim 15, wherein the ionic polymer is added in the amount of 1% by weight to 90% by weight based on the content of the nonionic polymer.

23. The method of claim 15, wherein the nanofiber has an average diameter between 10 nm and 1,000 nm.

24. The method of claim 15, wherein the heat-treated separation membrane has a porosity of 60% to 90%.
